(19) United States
(12) Patent Application Publication
(10) Pub. No.: US 2019/0255817 A1
(43) Pub. Date: Aug. 22, 2019

(54) Method of fabricating lignin based polymeric systems

(71) Applicant: The University of North Dakota, Twamley Hall, ND (US)

(72) Inventors: Surojit Gupta, Grand Forks, ND (US); Kathryn Marie Hall, Grand Forks, ND (US); Matt Ryan Fuka, Grand Forks, ND (US); Maharshi Dey, Grand Forks, ND (US); Sujan Kumar Ghosh, Fayetteville, AR (US); Yun Ji, Grand Forks, ND (US)

(21) Appl. No.: 15/932,226

(22) Filed: Feb. 16, 2018

(51) Int. Cl. B32B 21/08

(52) U.S. Cl. CPC B32B 21/08; B32B 2307/7163; B32B 2250/03

(57) ABSTRACT

A multi-layer bioplastic comprised of lignin and polylactic acid has increased tensile strength and displacement. The bioplastic is made through processing of individual layers of composite lignin/polylactic acid bioplastics and combining them with polylactic acid layer via lamination.

### STATEMENT OF GOVERNMENT INTEREST

This invention was made with government support under NSF EPSCoR IIA-1355466 awarded by The National Science Foundation. The government has certain rights in the invention.

### BACKGROUND

This application relates generally to polymeric systems, and specifically to lignin-based bioplastics.

Lignocellulose (or plant dry matter) is an abundantly available type of biomass occurring in naturally in plants, particularly in cell walls or wood that can potentially be used for various industrial applications. Lignocellulose is a widely available aromatic compound that is a recalcitrant organic polymer in biomass due to its rigid cross-linked structure and composition. Currently, 98% of lignocellulose produced by the pulp and paper industry is burned as a low-cost fuel and only 2% is put to other uses.

Lignocellulose contains carbohydrate polymers and lignin. The carbohydrate portion of lignocellulose makes up about two-thirds of the biomass, and can be used to produce ethanol among other uses. Lignin comprises about 15-30% of dry lignocellulose weight, and is an abundant aromatic compound. The quality of lignin particles, such as the chemical structure, molecular weight distribution, and the degree of cross linking, are affected by lignin isolation methods. For this reason, lignin products with non-uniform and non-standard quality make lignin difficult to use. Cost-effective, reliable methods for the conversion and application of lignin are technically challenging due to lignin's recalcitrant nature.

Other uses of lignin have been explored with little development, including failed attempts to incorporate lignin into thermoplastics, thermosets, and rubbers. For example, lignin has been combined with thermoplastics, thermosets, and rubbers. However, the mechanical behavior of these compositions is unreliable. Other methods have chemically treated lignin through methods such as alkylation and acetylation to encourage lignin compatibility with non-polar polymer matrices, but the results are environmentally unfriendly and very time consuming. With increased production of biomass resources, lignin is readily available but is not being effectively used.

### SUMMARY

In one embodiment, an article includes a first composite layer comprising a first polymer, lignin, and a first organic solvent, a first intermediate layer comprising a second polymer and a second organic solvent, the intermediate layer attached to the first composite layer, and a second composite layer comprising the first polymer, lignin, and the first organic solvent attached to the intermediate layer opposite the first composite layer, wherein the first composite layer, the intermediate layer, and the second composite layer are laminated together.

In another embodiment, an article includes a plurality of polymer lignin composite layers. Each of the plurality of polymer lignin composite layers includes a first composite layer comprising a first polymer, lignin, and a first organic solvent, an intermediate layer comprising a second polymer and a second organic solvent, the intermediate layer attached to the first composite layer, and a second composite layer comprising the first polymer, lignin, and the first organic solvent attached to the intermediate layer opposite the first composite layer, wherein the first composite layer, the intermediate layer, and the second composite layer are laminated together.

In a third embodiment, a method of making a bioplastic includes forming a first composite layer comprising a polymer and lignin in an organic solvent, forming an intermediate layer comprising the polymer in the organic solvent, forming a second composite layer comprising the polymer and the lignin in the organic solvent, aligning the intermediate layer between the first composite layer and the section composite layer, and laminating the first composite layer, the intermediate layer, and the second composite layer together.

### BRIEF DESCRIPTION OF THE DRAWINGS

FIG. 1A-1B are schematic diagrams of laminated multi-layer PLA-lignin composites.

FIGS. 2A-2C are schematic diagrams of single layer PLA-lignin composites.

FIG. 3A is a schematic flow chart of a method of making multi-layer PLA-lignin composites.

FIG. 3B is a photograph of the method of making a multi-layer PLA-lignin composite.

FIGS. 4A-4H are SEM photographs of laminated PLA-lignin composites.

FIGS. 5A-5B are plots of tensile strength versus displacement of single PLA layers made with dichloromethane as a solvent.

FIGS. 6A-6D are plots showing properties of various single PLA layers.

FIGS. 7A-7D are plots showing tensile strengths of various single PLA-lignin composite layers.

FIGS. 8A-8B are plots showing tensile strength of single PLA-lignin composite layers made with different sources of lignin.

FIGS. 9A-9C are plots showing tensile strength of various laminated multi-layer PLA-lignin composites.

FIGS. 10A-10B are plots showing tensile strength of single PLA layers reinforced with fibers and single PLA-lignin composite layers reinforced with fibers.

FIG. 11 is a plot showing tensile strength of PLA-lignin composites made with 3-D printing techniques.

### DETAILED DESCRIPTION

Lignin is a readily available biomass product that is currently under-utilized. For instance, the paper industry produces about 50-60 million tons of lignin per year. The amount of lignin produced each year is expected to increase as the result of recent bio refinery developments. The majority of lignin is typically burned as low cost fuel for steam and process heat in the paper industry due in part it is heterogeneity.

Lignin has significant, unrealized potential as a source for production of sustainable green materials. The use of lignin in composite polymers uses a readily available, low cost material to create environmentally friendly, UV resistant polymer materials that can later be applied to a number of industries, including, but not limited to, automotive, packaging, and textile applications, plastic products, or other industries. The resulting lignin based polymeric composites can replace traditional polymers but are environmentally safe.

In particular, lignin can be used to create a “green” or environmentally friendly polymer composite through the use of non-polar polymer matrices and as-received lignin particulates with no chemical treatments or additives to create polymer-lignin laminates with controlled mechanical properties and thicknesses. By using a microstructure design approach, the behavior of these laminates is less dependent on the source of lignin used.

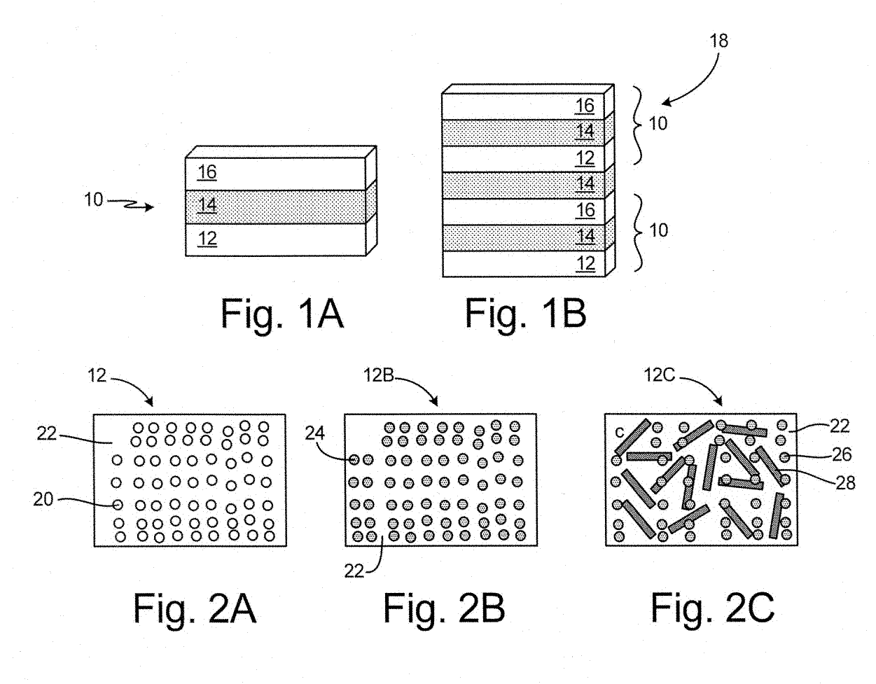

FIGS. 1A-1B are schematic diagrams of laminated multi-layer PLA-lignin composites. A three-layer PLA-lignin composite 10 is pictured in FIG. 1A, and a seven-layer PLA-lignin composite 18 is pictured in FIG. 1B. FIGS. 1A-1B will be discussed together.

Three-layer PLA-lignin composite 10 includes first composite layer 12, PLA layer 14, and second composite layer 16. First composite layer 12 includes both a polymer base, such as polylactic acid (PLA) and lignin. PLA is used as an example polymer, but may be substituted with any appropriate polymer. For example, the polymer can be a cellulose based plastic such as cellulose acetate, a protein such as gelatin, zein, kafirin, or wheat gluten, an aliphatic biopolyester such as polyhydroxybutyrates or PHBV3, a biopolymer from natural oil such as polyamide 11, a biodegreadable polyester such as polycaprolactone, or an alkaline descetylation of chitin such as chitosan.

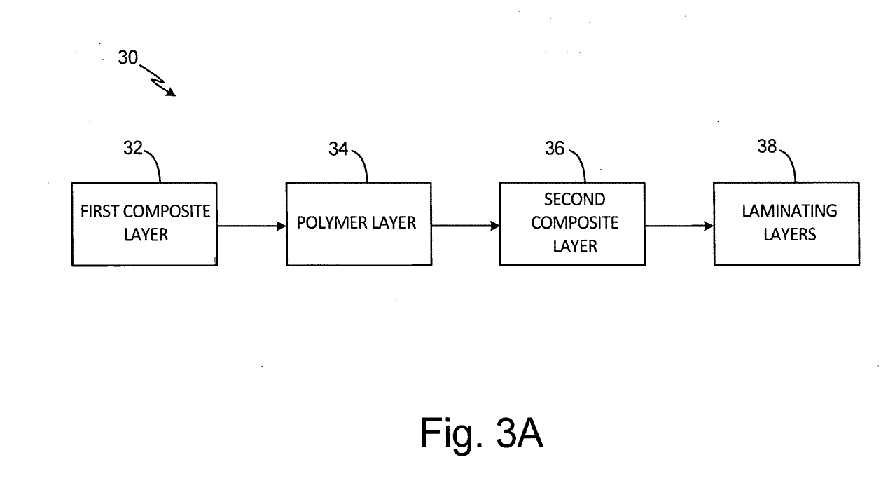

Three-layer PLA-lignin composite 10 can be fabricated using a microstructure as shown and discussed with reference to FIGS. 2A-2C below. Three-layer PLA-lignin composite 10 can be made by laminating the multiple layers in a lamination press or other consolidation device. For example, in three-layer PLA-lignin composite 10, PLA layer 14 acts as a bonding layer to join composite layers 12 and 16.

Composites layers 12 and 16 contain lignin. Lignin is the third major biomass component that forms structural materials in vascular plants and some algae. Lignin is a class of complex organic polymers with structures containing phenylpropanoid units including both aromatic and aliphatic groups. The chemical composition of lignin varies depending on its specific form. As a biopolymer, lignin is unique because of its heterogeneity (its lack of a defined primary structure).

Composite layer 12 may contain between 9 wt % and 57 wt % lignin. Sources of lignin can include industry standard lignin, such as lignin, sodium ligninsulfonate, lignin (alkaline), lignin (dealkaline). Composite layer 12 is attached to PLA layer 14. PLA layer 14 is a standard polymeric layer between composite layers 12, 16. PLA layer 14 acts as a bonding layer to join first and second composite layers 12 and 16. Second composite layer 16 is also comprised of both PLA and lignin. Composite layer 16 may contain between 9 wt % and 57 wt % lignin. The three layers 12, 14, 16, are laminated together to create a strong, multi-layer polymeric composite material.

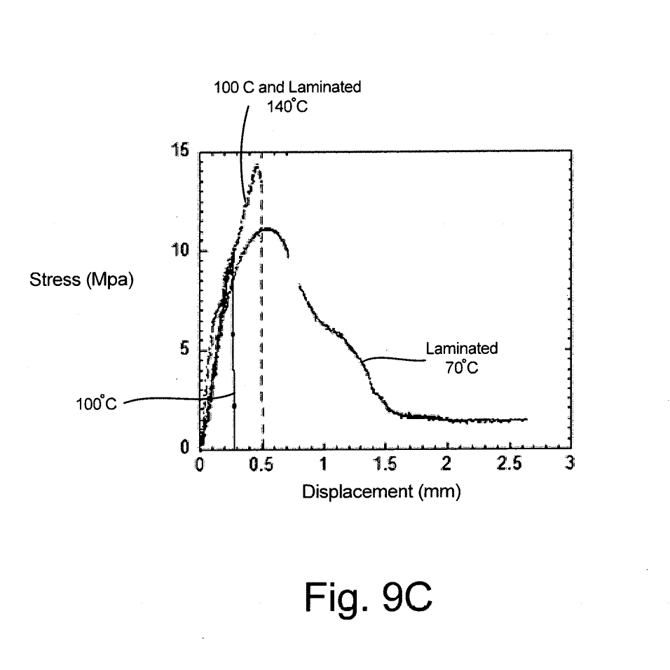

Layers 12, 14 and 16 can be attached through lamination processes. The tensile strength and ductility of such three-layer PLA-lignin composite 10 is discussed in reference to FIGS. 9A and 9B.

FIG. 1B depicts seven-layer PLA-lignin composite 18, which is a version of PLA-lignin composite 10 from FIG. 1A. PLA-lignin composite 18 contains two of PLA-lignin composite 10 laminated together with a lamination press (using both heat and force), with extra PLA layer 12 in between each composite 10. Typically, the temperature of lamination should be higher than 55 degrees Celsius, preferably 70 degrees Celsius. Each PLA-lignin composite 10 contains two composite layers 12, 16, and one PLA layer 14 in between the composite layers 12, 16. Seven-layer PLA-lignin composite 18 is created similarly to three-layer bioplastic 10 of FIG. 1A, but with a larger number of layers.

Seven-layer PLA-lignin composite 18 introduces more tensile strength to the multi-layer polymeric composite material because the lamination induces melting of the layers into each other, creating strong mechanical bonds The resulting tensile strength and displacement of composites 10, 18 are discussed in more detail with reference to FIGS. 9A-9B.

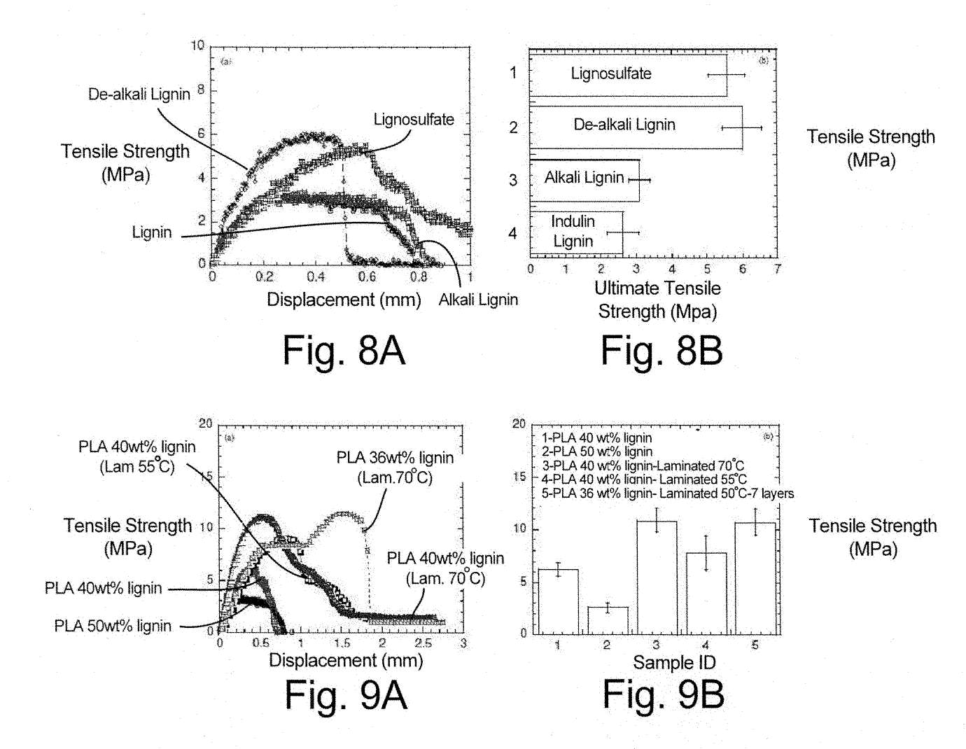

FIGS. 2A-2C are schematic diagrams of single layer PLA-lignin composites such as composite layers 12, 16 in FIGS. 1A-1B. FIG. 2A shows composite layer 12A containing lignin 20 in PLA 22. In FIG. 2A, layer 12A contains an “as received” lignin, where lignin 20 was not further modified prior to being made into layer 12A. Typically, lignin will be added so it is between 9 wt % and 50 wt % of the composite layer 12A. Ideally, lignin is between 16wt % and 50 wt %. Lignin is mixed with the polymer in ordinary methods, such as stirring, blending, or other appropriate means. The type of lignin used (which is usually dependent on its source) can affect tensile strength of the PLA-lignin composite, as discussed in reference to FIGS. 8A-8B.

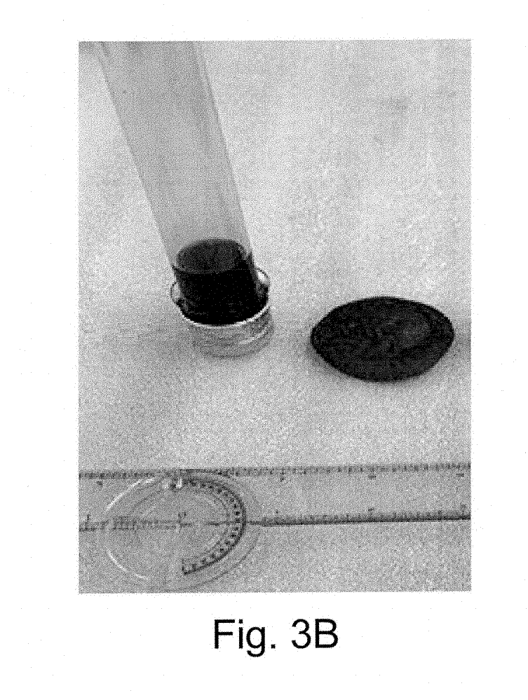

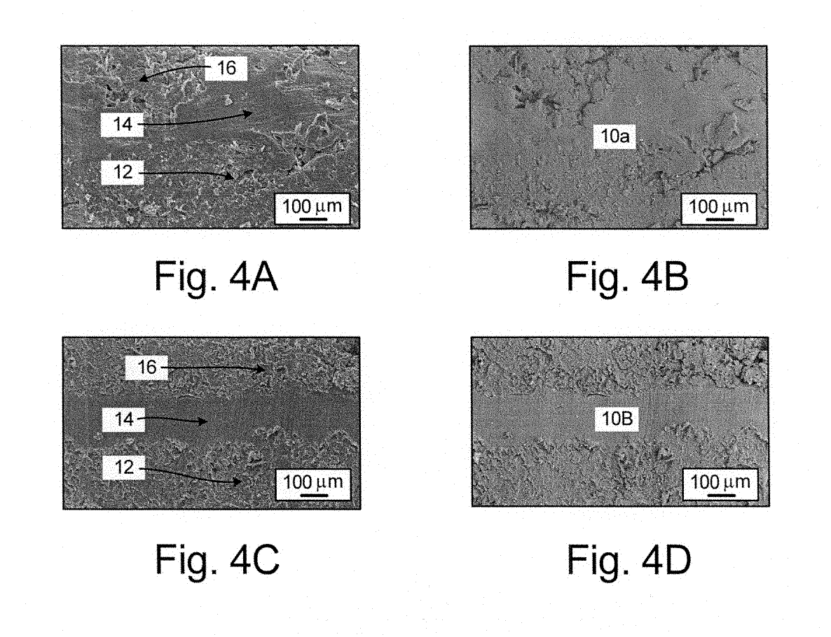

FIG. 2B shows composite layer 12B containing treated lignin 24 and PLA 22. Here, lignin 24 was treated prior to creating composite layer 12B. Lignin 24 has a treatment coating around it. In FIG. 2B, treated lignin 24 is chemically treated to create a coating. Alternatively, lignin 24 can be treated by being ball milled, freeze (cryogenic) milled, or otherwise treated. Treatments such as ball or freeze milling create smaller, more uniform shaped lignin particles that are better dispersed when dissolved in PLA. Chemical treatments can affect the structure of and coating on lignin particles; for instance, the hydroxide groups in lignin molecules can be converted to non-polar groups by chemical reactions like acetylation, methylation, oxidation, and esterification. Lignin can be treated with, for example, foramide, ammonia, acetone, DMSO-d6, tetrahydrofuran with lithium chloride, acrylic anhydride, butyric anhydride, methacrylic anhydride, acetic anhydride, ethyl acetate, 2-butanone, methanol, acetone, dioxane/water, 1,4-dixoane/water solution, dichloromethane, acetic ether, butyl alcohol, or ethylene glycol, among other chemicals. Chemically treating lignin particles can alter how they interact with PLA by making lignin particles more compatible with non-polar matrices. These alterations may change the resulting strength of the composite layers as shown in FIG. 3B, discussed below.

FIG. 2C shows composite layer 12C containing lignin 26, natural fibers 28, and PLA 22. Lignin 26 can be untreated or treated. Natural fibers 28 can be naturally occurring with lignin, such as grass or biomolecules. Alternatively, fibers 28 can be added, and can be, for example, silica fibers. Other variations of natural fibers 28 can include lignocellulose fibers such as bast fibers (jute, flax, hemp, kenaf, ramie), leaf fibers (abaca, sisal, pineapple), seed fibers (coir, cotton, kapok), core fibers (kenaf, hemp, jute), grass and reed fibers (wheat, corn, rice), and other types of lignocellulose fibers (wood, food and agricultural residue, recycled paper fibers, bamboo, rattan, roots); cellulose fibers such as cellulose, cellulose ethers, nanocellulose, and bacterial cellulose; other organic sources such as chitin and chitosan. Suitable inorganic fibers include glass fibers, microglass, carbon fiber, activated carbon fiber, hydrated magnesium silicate, potassium titanate, alumina, silica, wollastonite, rock wool, Basalt fibers, nanoclay, MAB phases, MAX phases and derivatives, or carbide such as silicon carbide.

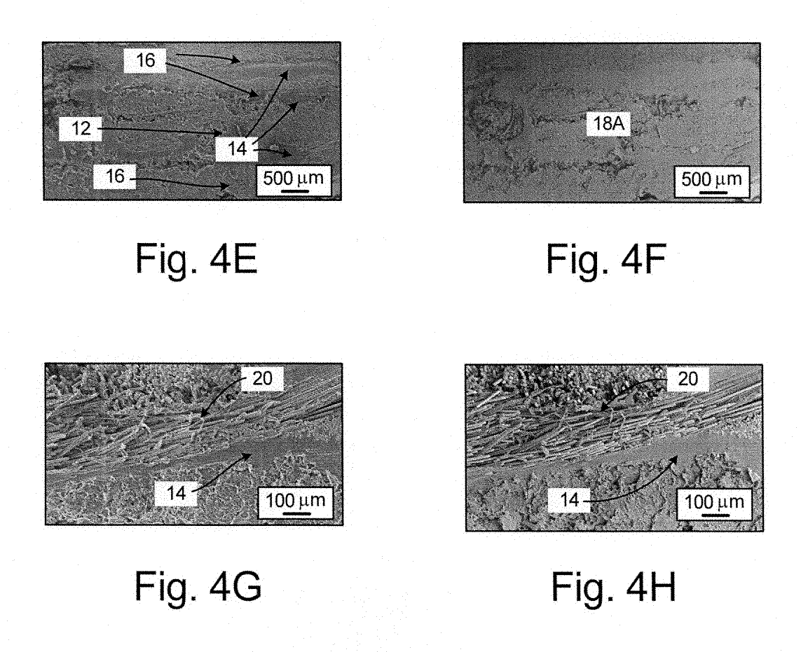

Natural fibers 28 add stiffness to the composite layer, the PLA layer, or can be used in an extra intermediary layer (see FIGS. 4G-4H). The type of lignin used, whether it is treated, and the amount of natural fibers in a composite layer can increase the composite layer's tensile strength and displacement under stress. This is discussed in more detail with reference to FIGS. 4G-4H, 8A-8B and 10A-10B.

FIG. 3A is a schematic flow chart depicting method 30 of making multi-layer PLA-lignin composites, such as PLA-lignin composite 10 in FIG. 1A. Method 30 is a general method of making multi-layer lignin-based bioplastic compounds.

First, in step 32, a first composite layer is made. The composite layer includes both a polymer base, such as polylactic acid (PLA) and lignin. Typically, a selection of PLA granules and lignin particles are dissolved in an organic solvent, such as dichloromethane, and stirred. Alternatively, about 5 g of PLA granules are dissolved in 50 mL of solvent for each sample. PLA can be commercially available polylactic acid. The composite layers shown in FIGS. 2A-2C can be made with a variety of solvents. Solvents appropriate for dissolving lignin in PLA, or treating lignin, can include foramide, ammonia, acetone, DMSO-d6, tetrahydrofuran with lithium chloride, acrylic anhydride, butyric anhydride, methacrylic anhydride, acetic anhydride, ethyl acetate, 2-butanone, methanol, acetone, dioxane/water, 1,4-dixoane/water solution, dichloromethane, acetic ether, butyl alcohol, or ethylene glycol, among others.

Lignin can be pre-treated prior to being dissolved. For instance, lignin can be cryogenic milled or ball milled to adjust particle size; lignin can be chemically treated as desired with one of the solvents discussed above; or natural fibers from other biomass can be added to lignin. This is discussed in more detail with reference to FIG. 2C. Lignin can be commercially available lignin, ligninsulfonate, lignin (alkaline), lignin (dealkaline), or other varieties. Lignin can be between 0.01 wt % and 99 wt % for the composite layer, preferably between 16 wt % and 50 wt % for mechanical strength. The composite layers shown in FIGS. 2A-2C can be made with a variety of solvents in combination with lignin.

Once the PLA and lignin are dissolved in an organic solvent, the solution is poured into a single layer in a coated mold (such as a PTFE mold). The sample is then cured in ambient air for up to 12 hours, and then removed from the mold.

Alternatively, PLA-lignin composite layers can be formed by using three dimensional printing technology. For instance, a prepared PLA-lignin composite solution can be loaded into a three dimensional printer and additively manufactured into the desired shape or layer. The desired shape or layer can then be cured (as described above with reference to method 30) in ambient air for up to twelve hours.

Next, in step 34, a PLA layer is made. The PLA layer will bond the first composite layer to the second composite layer and reside between the composite layers. The PLA layer is made in much the same way as the composite layer, but without lignin. Thus, PLA is dissolved in an organic solvent, the solution is poured into a coated mold, the solution is cured, and then the solution is removed from the mold. Appropriate solvents for dissolving PLA are listed below in Table 1.

TABLE 1
Appropriate solvents for dissolving PLA

| Group | Solvent | Category of Solvent |
|---|---|---|
| Alcohol | m-creso | Polar aprotic |
| Amine | Pyridine | Polar aprotic |
| | N-methylpyrrolidone | Polar aprotic |
| Aromatic hydrocarbon | Benzene | Non polar |
| Ester | c-butyrolactone | Polar aprotic |
| | Ethylacetate | Polar aprotic |
| | propylene-1,2-carbonate | Polar aprotic |
| Ether | Tetrahydrofuran | Polar aprotic |
| | 1,3-dioxolane | Polar aprotic |
| | 1,4-dioxane | Polar aprotic |
| Chlorinated solvent | Dichloromethane | Polar aprotic |
| | Chloroform | Polar aprotic |
| Ketone | Acetone | Polar aprotic |
| Nitrogen-containing | Nitrobenzene | Polar aprotic |
| | Acetonitrile | Polar aprotic |
| | Dimethylacetamide | Polar aprotic |

Third, in step 36, a second composite layer is made in the same way the first composite layer was made. Alternatively, both composite layers can be made simultaneously. The individual composite layers and PLA layer can be cured individually at this time, or curing can wait until after the layers are combined via lamination. Generally, each layer can be cured up to 24 hours. Alternatively, a first composite layer can be made and cured in ambient air, and the PLA layer can be formed on top of the cured first composite layer. Multiple layers can be added in this manner.

Finally, in step 38, the layers are laminated. Multiple layers are arranged such that the PLA layer is between the composite layers, and they are placed in a lamination press. The layers can be laminated, for example, at around 55 to 70 degrees Celsius for about 30 seconds while applying about 25 kN of force. The resulting final weight percent of lignin in the multi-layer composite depends on the number of composite layers and the original amount of lignin in those layers. For instance, a three-layer composite containing two composite layers each with 50 wt % lignin (that is, the sample contains 40% lignin by weight) would have a resulting 40 wt % lignin in the final laminated composite. This process can be repeated to create multi-layer compounds.

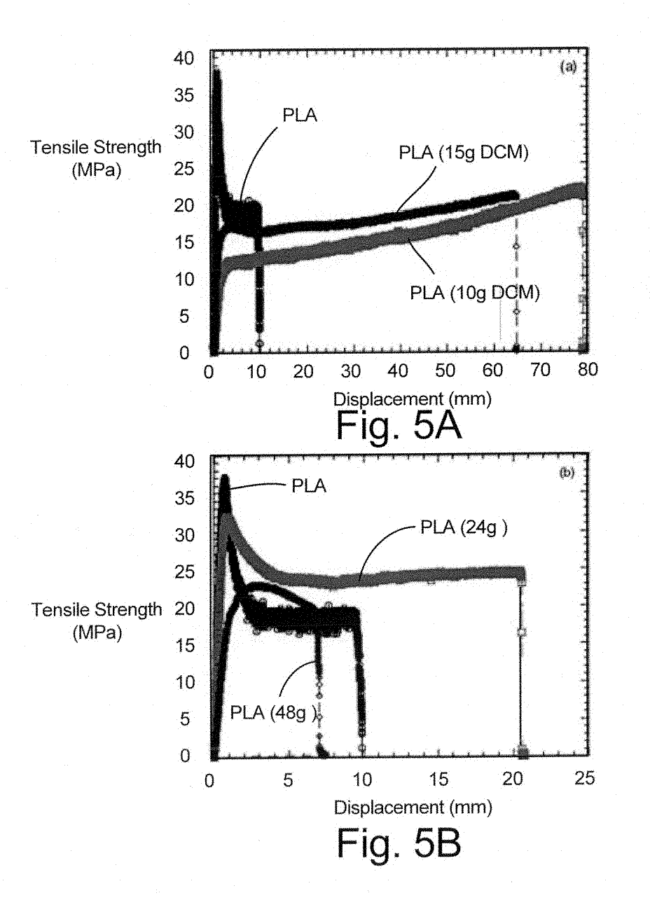

Samples made by method 30 were extensively tested, the results of which are described in reference to FIGS. 5-11. The samples made and tested by method 30 were all made with uniform shape. Thickness of the PLA-lignin composites made by this method varied depending on the number of layers and amounts of PLA and/or lignin used. Thicknesses are exhibited in Table 2 below.

TABLE 2
Thickness of different types of PLA based compositions

| Composition of Sample | Thickness (μm) |
|---|---|
| PLA | 140 ± 13 |
| 10 g PLA in DCM | 459 ± 61 |
| 15 g PLA in DCM | 647 ± 72 |
| 5 g PLA in 50 mL DCM, Sample of 24 g | 567 ± 28 |
| 5 g PLA in 50 mL DCM, Sample of 48 g | 1068 ± 59 |
| PLA with 2 wt % lignin | 127 ± 13 |
| PLA with 9 wt % lignin | 195 ± 29 |
| PLA with17 wt % lignin | 208 ± 18 |
| PLA with 40 wt % lignin | 383 ± 35 |
| PLA with 50 wt % lignin | 387 ± 51 |
| PLA with 50 wt % lignin | 693 ± 79 |
| (Containing 10 g PLA and 10 g lignin) | |
| PLA with 50 wt % lignin, | 363 ± 36 |
| Lignosulfonate lignin source | |
| PLA with 50 wt %, | 486 ± 73 |
| alkaline lignin source | |
| PLA with 50 wt % lignin, | 443 ± 79 |
| dealkaline lignin source | |
| PLA with40 wt % lignin, | 1062 ± 305 |
| laminated at 70° C. | |
| PLA with 40 wt % lignin, | 1333 ± 419 |
| laminated-glass fiber | |

FIG. 3B is a photograph of the method of making a multi-layer PLA-lignin composite. FIG. 3B depicts a preliminary step in making composite layers 12 and 16 where the lignin used is treated prior to mixing with the PLA. As described with reference to FIG. 2B, lignin 24 can be treated by being ball milled, freeze (cryogenic) milled, or chemically treated. Chemically treating lignin particles can alter how they interact with PLA by making lignin more compatible with non-polar matrices. These chemical alterations change the appearance and resulting strength of composite layers 12, 14, when they are made in steps 32, 36 of method 30. These chemical alterations can be visually seen in the photograph of FIG. 3B. In FIG. 3B, the brown liquid in the tube is lignin partially dissolved in acetone after mixing. The PLA-lignin sample with chemically treated lignin is shown on the right.

FIGS. 4A-4H are SEM micrographs of cross-sections of a PLA lignin composites, and will be discussed together.

FIGS. 4A-4D show three layer composites of PLA with 40 wt % lignin. FIGS. 4A-4B show composite 40 laminated at 70 degrees Celsius from different views. FIGS. 4C-4D show composite 48 laminated at 55 degrees Celsius from different views. Composite 40 in FIGS. 4A-4B contains PLA 50 wt % lignin layers 42, 46, and PLA layer 44 in the middle. Composite 48 in FIGS. 4C-4D contains PLA 50 wt % lignin layers 50, 54, and PLA layer 52 in the middle. PLA layer 44 in composite 40, which was laminated at a higher temperature, is more diffused than PLA layer 52, which was laminated at a lower temperature. The dispersion of PLA layers can be tailored by utilizing varying temperatures for lamination.

FIGS. 4E-4F shows seven layer composite 60 of PLA with 36 wt % lignin laminated at 70 degrees. Composite 60 includes PLA 50% lignin layers 62, 64, 66, with PLA layers 68, 70 and 72. FIG. 4F shows the BSE image of composite 60. FIGS. 4G-4H shows an SE image of PLA 40 wt % laminated glass fiber 20 for comparison to PLA-lignin composites of FIGS. 4A-4F.

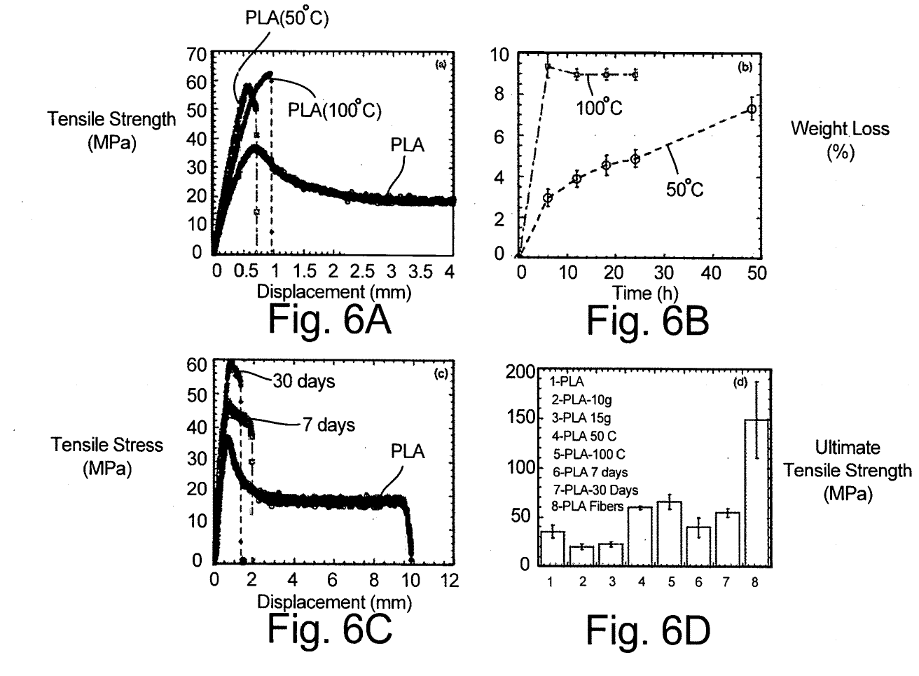

FIGS. 5A-5B and 6A-6D depict tensile strength testing of PLA layers without lignin. Layers made from PLA dissolved in dichloromethane (DCM), can be used as intermediary layer such as layer 14 in FIG. 1A. These PLA layers also serve as a base to compare with the tensile strength of PLA-lignin layers and completed PLA-lignin composites. Each PLA layer tested with the same shape and size for consistency, but had varying compositions and thicknesses as described in Table 2 above.

FIGS. 5A-B are graphs showing tensile strength and displacement of multi-layer lignin-infused PLA compounds by showing tensile strength for varying concentrations of solvent and varying thicknesses of PLA layers. FIG. 5A shows tensile strength in MPa versus displacement in millimeters of PLA samples with varying amounts of the solvent dichloromethane (DCM). The samples tested include 5 g PLA in 50 mL DCM (“baseline PLA”), 10 g PLA in 50 mL DCM, and 15 g PLA in 50 mL DCM. PLA by itself had an average tensile strength of about 34.7 MPa. However, 10 g PLA with DCM and 15 g PLA with DCM have average tensile strengths of about 20 MPa and 23 MPa, respectively. Thus, the higher the concentration of DCM, the lower the average tensile strength of the PLA-DCM layer.

FIG. 5B shows tensile strength in MPa versus displacement in millimeters of PLA samples mixed with DCM at varying thicknesses based on a 5 g PLA in 50 mL DCM sample. The samples tested in FIG. 5B include a baseline PLA sample (congruent to the baseline PLA sample in FIG. 5A), 24 g of PLA-DCM, and 48 g of PLA-DCM. The baseline PLA sample had a thickness of about 140 μm. The 24 g and 48 g PLA-DCM samples had higher thicknesses of about 567 μm and 1068 μm, respectively. When tested for average tensile strength, the baseline PLA samples had an average tensile strength of about 34.7 MPa. The 24 g PLA samples had an average tensile strength of about 31 MPa, while the 48 g PLA samples had an average tensile strength of about 21 MPa. The tensile strength of the baseline PLA sample was the highest. However, the displacement of 24 g and 48 g PLA samples was more even. Thus, the 24 g and 48 g PLA samples were more plastic than the baseline PLA samples.

FIGS. 6A-6D depict further tensile strength testing on treated PLA samples. FIG. 6A shows tensile strength testing of PLA at treated different temperatures. Samples examined for FIG. 6A include a baseline PLA sample, a PLA sample treated at 50 degrees Celsius for 24 hours, and a PLA sample treated at 100 degrees Celsius for 24 hours. Comparatively, PLA held at 50 degrees Celsius for 24 hours and PLA held at 100 degrees Celsius for 24 hours show higher tensile strength that a baseline PLA, and had average tensile strengths of about 59.5 MPa and 66.5 MPa, respectively. Overall, PLA samples treated at 100 degrees Celsius for 24 hours had the highest tensile strength. However, both the samples treated at 50 degrees and 100 degrees were less plastic (had lower displacement) than baseline PLA samples.

FIG. 6B extends the analysis of the samples in FIG. 6A, and shows PLA weight loss kinetics versus time. The loss of volatile DCM over time from all the PLA samples increases tensile strength of those samples, but decreases the ductility of the samples. The presence of DCM in the samples enhances the plasticity (displacement) of the layers.

This was similarly observed in FIG. 6C, which shows PLA tensile strength testing after curing for a designated number of days in ambient air. Samples tested in FIG. 6C include a baseline PLA sample, a PLA sample cured for 7 days, and a PLA sample cured for 30 days, all cured in ambient air. When a PLA layer sample was cured in ambient air for 7 days, the average tensile strength increased to about 40 MPa. For a PLA layer cured in ambient air for 30 days, the average tensile strength was about 55.5 MPa. However, the ductility (displacement) of the samples decreased the longer the PLA samples were cured.

FIG. 6D summarizes tensile strength testing results of various types of engineered PLA shown in FIGS. 6A-6B, in addition to a sample reinforced with fibers. FIG. 6D shows the ultimate tensile strength (UTS) of samples, instead of the average tensile strength. Overall, the PLA sample reinforced with fibers (as described in reference to FIGS. 2C and 4G-4H) had substantially higher tensile strength than any of the cured PLA samples earlier discussed. However, out of the cured PLA samples discussed with reference to FIGS. 6A-6C, the PLA treated at 50 degrees Celsius or 100 degrees Celsius for 24 hours had the best ultimate tensile strength.

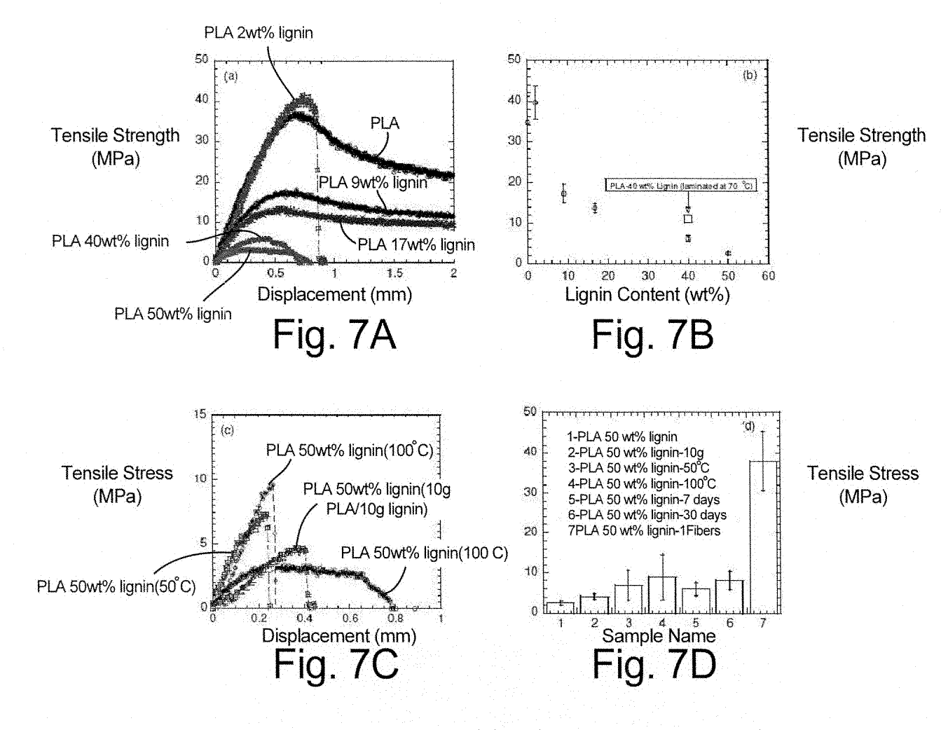

FIGS. 7A-7D and 8A-8B show data about the tensile strength and ductility of single layer PLA-lignin composites, such as layers 12 and 16 in FIG. 1A. FIGS. 7A-7D show tensile strength versus displacement plots for varying single layer PLA-lignin composites. In general, the addition of lignin to single PLA layers significantly reduced tensile strength of the samples, with the exception of the PLA 2 wt % lignin layer (having an average tensile strength of 39.6 MPa). The single layer composite samples and their average tensile strengths are summarized below in Table 3.

TABLE 3
Average tensile strengths for single layer PLA-lignin composite layers.

| Sample | Layers | Average Tensile Strength |
|---|---|---|
| Baseline PLA (No lignin) | 1 | 34.7 MPa |
| PLA 9 wt % lignin | 1 | 13.7 MPa |
| PLA 17 wt % lignin | 1 | 11.5 MPa |
| PLA 40 wt % lignin | 1 | 6.2 MPa |
| PLA 50 wt % lignin | 1 | 2.6 MPa |

FIG. 7A shows the tensile strength versus displacement of these samples. FIG. 7B shows tensile strength of these samples compared to lignin content (wt %).

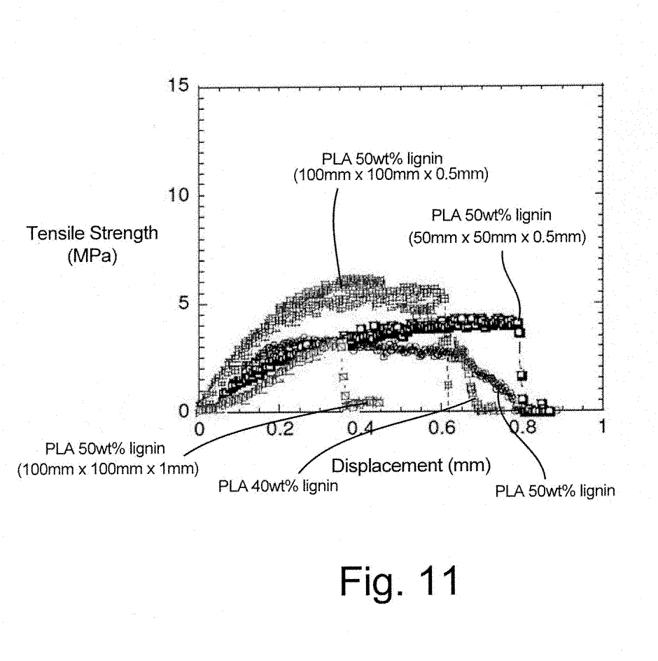

FIG. 7C shows tensile strength versus displacement of PLA 50 wt % lignin samples cured at different temperatures for 24 hours. Samples shown in FIG. 7C include PLA 50 wt % lignin (not treated), PLA 50 wt % lignin treated at 50 degrees Celsius for 24 hours, PLA 50 wt % lignin treated at 100 degrees Celsius for 24 hours, PLA 50 wt % lignin made with 10 g PLA and 10 g lignin. Samples treated at 50 degrees Celsius or 100 degrees Celsius for 24 hours had higher average tensile strength comparatively, at 7.2 MPa and 9.2 MPa, respectively. FIG. 7D summarizes the ultimate tensile strengths for varying single layer PLA-lignin composite samples shown in FIGS. 7A-7C. Single PLA-lignin layers reinforced with fibers showed the highest ultimate tensile strength of about 38 MPa. These are discussed in more depth with reference to FIG. 11. Thus, PLA-lignin sample tensile strengths followed similar patterns of the PLA (without lignin) samples tested in FIGS. 5A-5B and 6A-6D, but had significantly lower tensile strength than PLA without lignin. Overall, the PLA-lignin sample with the highest ultimate tensile strength was the sample with reinforcing fibers.

FIGS. 8A-8B compare the tensile strength versus displacement of PLA 50 wt % lignin where the source of lignin used varies. Sources of lignin for PLA-lignin composites can include alkaline lignin, dealkaline lignin, lingosulfate, kraft lignin, soda lignin, milled wood lignin, mild acidolysis lignin, cellulolytic enzyme lignin, enzymatic mild acidolysis lignin, organosolvent lignin, and insulin lignin.

The samples shown in FIGS. 8A-8B include PLA-lignin samples made with lignosulfate, alkali lignin, dealkaline lignin, and indulin lignin. In general, regardless of the form of lignin used to create the composite layers, the PLA-lignin layers exhibited similar tensile strength and ductility behavior, as shown in FIG. 8A. This allows for flexibility in lignin source when making PLA-lignin composites. FIG. 8B compares the differing types or lignin with ultimate tensile strength. Dealkaline lignin and lignosulfonate showed the highest ultimate tensile strength, at about 6 MPa and 5.6 MPa, respectively.

FIGS. 9A-9C show data regarding the tensile strength and displacement of multi-layer laminated PLA-lignin composites, such as composite 10 in FIG. 1A. FIGS. 9A-9C exhibit the behavior of composite samples containing Three-Layer PLA 40 wt % lignin (laminated at 55 degrees Celsius), Three-Layer PLA 40 wt % lignin (laminated at 70 degrees Celsius), and Seven-Layer PLA 36 wt % lignin (laminated at 55 degrees Celsius). Additionally, a Three-Layer PLA 40 wt % lignin sample where each layer was dried at 100 degrees Celsius prior to lamination at 140 degrees Celsius was tested. Overall, all laminated samples are more ductile than single layer PLA-lignin composites. Additionally, the average tensile strength improved compared to single layer PLA-lignin composites, as shown below in Table 4 below.

TABLE 4
Average tensile strength for multi-layer PLA-lignin composites

| | | Lamination | Average Tensile |
|---|---|---|---|
| Sample | Layers | Temperature | Strength |
| PLA 40 wt % lignin | 3 | 70 degrees Celsius | 10.9 MPa |
| PLA 40 wt % lignin | 3 | 55 degrees Celsius | 7.8 MPa |
| PLA 36 wt % lignin | 7 | 70 degrees Celsius | 10.7 MPa |
| PLA 40 wt % lignin | 3 | 140 degrees Celsius | 13.7 MPa |
| *Dried at 100 degrees | | | |
| Celsius Before | | | |
| Lamination | | | |

FIG. 9B shows the ultimate tensile strength (UTS) of each sample. Overall, the 3-layer PLA 40 wt % lignin laminated at 70 degrees Celsius, and the 7-layer PLA 36 wt % lignin laminated at 70 degrees Celsius showed the highest average UTS. FIG. 9C shows tensile strength versus displacement of the varying PLA-lignin composites. In FIG. 9C, the PLA 40 wt % lignin sample where each layer was dried at 100 degrees Celsius prior to being laminated at 140 degrees Celsius had the highest tensile strength, but lower displacement. Thus, mechanical strength of the PLA-lignin composites was increased with pre-drying layer and with higher lamination temperatures.

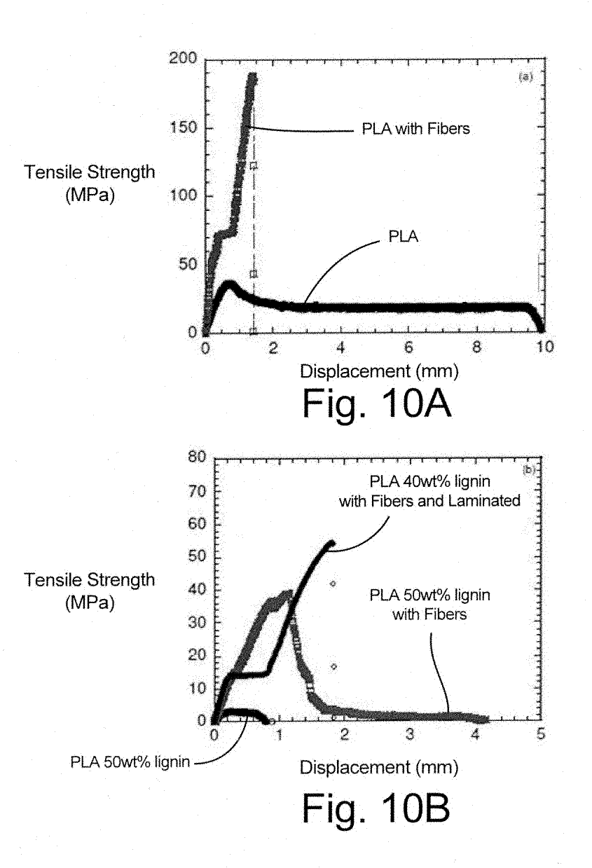

FIGS. 10A-10B show tensile strength versus displacement for PLA compositions with reinforcing fibers, such as composite layer 12C shown in FIG. 2C. Appropriate fibers can include silica fibers, or other fibers listed in reference to FIG. 2C. FIG. 10A shows tensile strength versus displacement of PLA layers (such as those discussed with reference to FIGS. 5 and 6), but with reinforcing fibers. Samples in FIG. 10A are samples of baseline PLA (5 g PLA in 50 mL DCM) and PLA with reinforcing fibers. The addition of reinforcing fibers can enhance the ultimate tensile strength of a base PLA layer from about 34.7 MPa on average to about 149 MPa on average.

FIG. 10B shows tensile strength versus displacement of PLA-lignin composites containing reinforcing fibers. Samples shown in FIG. 10B include 3-layer PLA 50 wt % lignin, 3-layer PLA 50 wt % lignin (reinforced with fibers), and 3-layer PLA 40 wt % lignin (laminated and reinforced with fibers). The ultimate tensile strength of a single layer PLA 50 wt % lignin reinforced with fibers increases to about 38.5 MPa on average, compared to just 2.6 MPa on average for samples without reinforcing fibers. A multi-layer laminated PLA-lignin composite has an even higher ultimate tensile strength of about 53 MPa on average.

FIG. 11 shows tensile strength versus displacement for various 3-D printed PLA-lignin composites. All 3-D printed PLA-lignin composite samples exhibited similar behavior, which is summarized below in Table 5.

TABLE 5
Tensile strengths of 3-D printed PLA-lignin composites

| | | Average Tensile |
|---|---|---|
| Sample | 3-D Printing Size | Strength |
| PLA 50 wt % lignin | 50 mm × 50 mm × 0.5 mm | 4.34 MPa |
| PLA 50 wt % lignin | 100 mm × 100 mm × 1 mm | 3.40 MPa |
| PLA 50 wt % lignin | 100 mm × 100 mm × 0.5 mm | 5.07 MPa |

Using unmodified lignin to create composite bioplastics is a potential new use for readily available lignin. Multi-layer PLA-lignin composites, laminated at high temperatures, maintained the best ultimate tensile strengths on average. The addition of reinforcing fibers to the composites further increased the tensile strength of these PLA-lignin composites.

Overall, multi-layer PLA-lignin composites with about 36 to 40 wt % lignin showed promising mechanical behavior for uses in a variety of industries requiring polymer materials. Specifically, these multi-layer composite materials showed increased strength and ductility useful for applications such as automotive, aerospace, machining, or others.

The use of lignin in composite polymers uses a readily available, low cost material to create environmentally friendly, UV resistant polymer materials that can later be applied to a number of industries, including, but not limited to, automotive applications. The resulting lignin based polymeric composites can replace traditional polymers but are environmentally safe.

Discussion of Possible Embodiments

The following are non-exclusive descriptions of possible embodiments of the present invention.

An article includes a first composite layer comprising a first polymer, lignin, and a first organic solvent, a first intermediate layer comprising a second polymer and a second organic solvent, the intermediate layer attached to the first composite layer, and a second composite layer comprising the first polymer, lignin, and the first organic solvent attached to the intermediate layer opposite the first composite layer, wherein the first composite layer, the intermediate layer, and the second composite layer are laminated together.

The article of the preceding paragraph can optionally include, additionally and/or alternatively, any one or more of the following features, configurations and/or additional components:

The first and second polymers are selected from the group consisting of polylactic acid, cellulose acetate, gelatin, zein, kafirin, wheat gluten, polyhydroxybutyrates, PHBV3, polyamide 11, polycaprolactone, and chitosan.

The lignin is selected from the group consisting of alkaline lignin, dealkaline lignin, lingosulfate, kraft lignin, soda lignin, milled wood lignin, mild acidolysis lignin, cellulolytic enzyme lignin, enzymatic mild acidolysis lignin, organosolvent lignin, and insulin lignin.

The first and second composite layers comprise between 0.01 and 99 percent by weight lignin.

The first and second composite layers comprise between 16 and 50 percent by weight lignin.

The lignin is compound is ball milled lignin, freeze milled lignin, or chemically treated lignin.

The first organic solvent is selected from the group consisting of dichloromethane, foramide, ammonia, acetone, DMSO-d6, tetrahydrofuran with lithium chloride, acrylic anhydride, butyric anhydride, methacrylic anhydride, acetic anhydride, ethyl acetate, 2-butanone, methanol, acetone, dioxane/water, 1,4-dixoane/water solution, dichloromethane, acetic ether, butyl alcohol, and ethylene glycol.

The second organic solvent is selected from the group consisting of dichloromethane, m-creso, pydridine, N-methylpyrrolidone, benzene, c-butyrolactone, ethylacetate, propylene-1,2-carbonate, tetrahydrofuran, 1,3-dioxolane, and 1,4-dioxane.

The first composite layer, the second composite layer, or the intermediary layer further comprise one or more fibers.

The one or more fibers are selected from the group consisting of bast fibers, leaf fibers, seed fibers, core fibers, grass fibers, reed fibers, lignocellulose fibers, cellulose fibers such as cellulose, chitin, chitosan, glass fibers, microglass, carbon fiber, activated carbon fiber, hydrated magnesium silicate, potassium titanate, alumina, silica, wollastonite, rock wool, Basalt fibers, nanoclay, MAB and MAX phases, and carbides.

An article includes a plurality of polymer lignin composite layers. Each of the plurality of polymer lignin composite layers includes a first composite layer comprising a first polymer, lignin, and a first organic solvent, an intermediate layer comprising a second polymer and a second organic solvent, the intermediate layer attached to the first composite layer, and a second composite layer comprising the first polymer, lignin, and the first organic solvent attached to the intermediate layer opposite the first composite layer, wherein the first composite layer, the intermediate layer, and the second composite layer are laminated together.

A method of making a bioplastic includes forming a first composite layer comprising a polymer and lignin in an organic solvent, forming an intermediate layer comprising the polymer in the organic solvent, forming a second composite layer comprising the polymer and the lignin in the organic solvent, aligning the intermediate layer between the first composite layer and the section composite layer, and laminating the first composite layer, the intermediate layer, and the second composite layer together.

The method of the preceding paragraph can optionally include, additionally and/or alternatively, any one or more of the following features, configurations and/or additional components:

Making the first composite layer and making the second composite layer includes dissolving the polymer and the lignin in the organic solvent to create a mixed solution, casting the mixed solution into a mold; and curing the mixed solution.

Forming the first composite layer, the intermediate layer, and the second composite layer comprise additive manufacturing.

The lignin is treated prior to dissolution such that the lignin compound is ball milled lignin, freeze milled lignin, or chemically treated lignin.

The method includes mixing fibers into the first composite layer, the intermediate layer, or the second composite layer prior to laminating the first composite layer, the intermediate layer, and the second composite layer together.

Laminating the first composite layer, the intermediate layer, and the second composite layer together comprises heating the layers to at least 55 degrees Celsius.

Laminating the first composite layer, the intermediate layer, and the second composite layer together comprises heating the layers to at least 70 degrees Celsius.

The method includes treating the first composite layer, the intermediate layer, and the second composite layer to at least 50 degrees Celsius for 24 hours.

The method includes treating the first composite layer, the intermediate layer, and the second composite layer to at least 100 degrees Celsius for 24 hours.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment(s) disclosed, but that the invention will include all embodiments falling within the scope of the appended claims.

1. An article comprising:
a first composite layer comprising a first polymer, lignin, and a first organic solvent;
an intermediate layer comprising a second polymer and a second organic solvent, the intermediate layer attached to the first composite layer; and
a second composite layer comprising the first polymer, lignin, and the first organic solvent attached to the intermediate layer opposite the first composite layer, wherein the first composite layer, the intermediate layer, and the second composite layer are laminated together.

2. The article of claim 1, wherein the first and second polymers are selected from the group consisting of polylactic acid, cellulose acetate, gelatin, zein, kafirin, wheat gluten, polyhydroxybutyrates, PHBV3, polyamide 11, polycaprolactone, and chitosan.

3. The article of claim 1, wherein the lignin is selected from the group consisting of alkaline lignin, dealkaline lignin, lingosulfate, kraft lignin, soda lignin, milled wood lignin, mild acidolysis lignin, cellulolytic enzyme lignin, enzymatic mild acidolysis lignin, organosolvent lignin, and insulin lignin.

4. The article of claim 1, wherein the first and second composite layers comprise between 0.01 and 99 percent by weight lignin.

5. The article of claim 4, wherein the first and second composite layers comprise between 16 and 50 percent by weight lignin.

6. The article of claim 1, wherein the lignin is compound is ball milled lignin, freeze milled lignin, or chemically treated lignin.

7. The article of claim 1, wherein the first organic solvent is selected from the group consisting of dicholormethane, foramide, ammonia, acetone, DMSO-d6, tetrahydrofuran with lithium chloride, acrylic anhydride, butyric anhydride, methacrylic anhydride, acetic anhydride, ethyl acetate, 2-butanone, methanol, acetone, dioxane, 1,4-dixoane/water solution, dichloromethane, acetic ether, butyl alcohol, and ethylene glycol.

8. The article of claim 1, wherein the second organic solvent is selected from the group consisting of dichloromethane, m-creso, pydridine, N-methylpyrrolidone, benzene, c-butyrolactone, ethylacetate, propylene-1,2-carbonate, tetrahydrofuran, 1,3-dioxolane, and 1,4-dioxane.

9. The article of claim 1, wherein the first composite layer, the second composite layer, or the intermediary layer further comprise one or more fibers.

10. The article of claim 9, wherein the one or more fibers are selected from the group consisting of bast fibers, leaf fibers, seed fibers, core fibers, grass fibers, reed fibers, lignocellulose fibers, cellulose fibers such as cellulose, chitin, chitosan, glass fibers, microglass, carbon fiber, activated carbon fiber, hydrated magnesium silicate, potassium titanate, alumina, silica, wollastonite, rock wool, Basalt fibers, nanoclay, MAB phases, MAX phases, and carbides.

11. An article comprising:
a plurality of polymer lignin composite layers, each of the plurality of polymer lignin composite layers comprising:
a first composite layer comprising a first polymer, lignin, and a first organic solvent;
an intermediate layer comprising a second polymer and a second organic solvent, the intermediate layer attached to the first composite layer; and
a second composite layer comprising the first polymer, lignin, and the first organic solvent attached to the intermediate layer opposite the first composite layer, wherein the first composite layer, the intermediate layer, and the second composite layer are laminated together.

12. A method of making a bioplastic comprising:
forming a first composite layer comprising a polymer and lignin in an organic solvent;
forming an intermediate layer comprising the polymer in the organic solvent;
forming a second composite layer comprising the polymer and the lignin in the organic solvent;
aligning the intermediate layer between the first composite layer and the section composite layer; and
laminating the first composite layer, the intermediate layer, and the second composite layer together.

13. The method of claim 12, wherein making the first composite layer and making the second composite layer comprises:
dissolving the polymer and the lignin in the organic solvent to create a mixed solution;
casting the mixed solution into a mold; and
curing the mixed solution.

14. The method of claim 12, wherein forming the first composite layer, the intermediate layer, and the second composite layer comprise additive manufacturing.

15. The method of claim 12, wherein the lignin is treated prior to dissolution such that the lignin compound is ball milled lignin, freeze milled lignin, or chemically treated lignin.

16. The method of claim 12, further comprising mixing fibers into the first composite layer, the intermediate layer, or the second composite layer prior to laminating the first composite layer, the intermediate layer, and the second composite layer together.

17. The method of claim 12, wherein laminating the first composite layer, the intermediate layer, and the second composite layer together comprises heating the layers to at least 55 degrees Celsius.

18. The method of claim 17, wherein laminating the first composite layer, the intermediate layer, and the second composite layer together comprises heating the layers to at least 70 degrees Celsius.

19. The method of claim 12, further comprising treating the first composite layer, the intermediate layer, and the second composite layer to at least 50 degrees Celsius for 24 hours.

20. The method of claim 19, further comprising treating the first composite layer, the intermediate layer, and the second composite layer to at least 100 degrees Celsius for 24 hours.
